(19) United States
(12) Patent Application Publication
(10) Pub. No.: US 2002/0098388 A1
(43) Pub. Date: Jul. 25, 2002

(54) Recording medium substrate having uniform texture and texturing apparatus therefor

(75) Inventors: Susumu Yoshida, Kawasaki (JP); Takashi Toyoguchi, Higashine (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 09/820,259

(22) Filed: Mar. 28, 2001

(30) Foreign Application Priority Data
Dec. 12, 2000 (JP) 2000-377031

(51) Int. Cl. G11B 5/82

(52) U.S. Cl. 428/694 TR

(57) ABSTRACT

An abrasive tape on a contact member is urged against the surface of a rotating substrate for a recording medium. Abrasive grains are held on the abrasive tape, for example. The abrasive grains serve to form fine scratches on the surface of the substrate. The fine scratches correspond to a texture. The contact member is moved in the radial or centrifugal direction of the substrate. The rotation rate of the substrate gets slower in response to the movement of the contact member in the centrifugal direction. A constant relative velocity can always be established between the contact member and the rotating substrate. A constant surface roughness can be established over the entire surface of the substrate.

### BACKGROUND OF THE INVENTION

1. Field of the Invention

The present invention relates to a recording medium incorporated in a recording medium drive or storage device such as a hard disk drive, for example. In particular, the invention relates to a texturing apparatus for establishing a texture on the surface of a substrate utilized in a recording medium such as a magnetic recording disk.

2. Description of the Prior Art

As disclosed in Japanese Patent Application Laid-open No. 07-244845, a texturing apparatus is conventionally employed to establish a texture over the surface of a substrate utilized in a magnetic recording disk. The texturing apparatus is designed to urge an abrasive tape against the surface of the disk-shaped substrate rotating around a rotational spindle. Abrasive grains adhered to the abrasive tape serve to form fine scratches, namely, the texture, on the surface of the substrate. A magnetic film is thereafter formed to extend over the surface of the substrate. When the magnetic recording disk utilizing the textured substrate is incorporated in a hard disk drive, for example, the texture serves to prevent a head slider from sticking to the surface of the magnetic recording disk. The texture also contributes to establishment of the magnetic anisotropy in the magnetic film over the magnetic recording disk. The texture is thus expected to lead to realization of a still higher recording density in the magnetic recording disk.

The conventional magnetic recording disk utilizing the aforementioned textured substrate in fact suffers from the variation or irregularity in the surface roughness in the radial direction of the disk-shaped substrate. The surface roughness tends to get larger in the central area as compared with the peripheral area on the magnetic recording disk. If a surface roughness is set enough to prevent adsorption of a head slider at a region closer to the periphery of the substrate, the magnetic recording medium inevitably suffers from an excessive surface roughness at a region closer to the center. Accordingly, the flying height of the head slider should be determined on the basis of the excessive surface roughness so as to reliably avoid collision between the head slider and the magnetic recording disk. However, an increase in the flying height of the head slider is a factor to hinder realization of a still higher recording density in the magnetic recording disk.

The conventional magnetic recording disk utilizing the aforementioned textured substrate also suffers from the variation in a so-called cross angle in the radial direction of the disk-shaped substrate. The cross angle tends to get larger in the central area as compared with the peripheral area on the magnetic recording disk. The varied cross angle induces the irregularity in the magnetic characteristic of the magnetic film spreading over the surface of the disk-shaped substrate. The varied magnetic characteristic over the magnetic recording disk also is a factor to hinder realization of a still higher recording density in the magnetic recording disk.

### SUMMARY OF THE INVENTION

It is accordingly an object of the present invention to provide a texturing apparatus capable of establishing a texture on the surface of a substrate so as to realize a still higher recording density in a recording medium utilizing the substrate.

According to the present invention, there is provided a texturing apparatus for a recording medium substrate, comprising: a rotational spindle supported for rotation in the attitude perpendicular to a predetermined datum plane; a contact member supported for movement in the radial direction of the rotational spindle along the datum plane; and a drive connected to the rotational spindle so as to vary the rotation rate of the rotational spindle in response to movement of the contact member.

When a substrate for a recording medium is mounted on the rotational spindle in the texturing apparatus, the substrate is allowed to rotate around the rotational axis of the rotational spindle within the datum plane. The contact member can be urged against the surface of the rotating substrate. If abrasive grains are supplied between the contact member and the rotating substrate, the abrasive grains serve to generate fine scratches on the surface of the substrate. The fine scratches form a so-called texture on the surface of the substrate.

In particular, the contact member can be moved in the radial direction of the rotating substrate in the texturing apparatus. A constant relative velocity can be maintained between the contact member and the rotating substrate on the basis of the position of the contact member in the radial direction and the rotation rate of the rotational spindle. Specifically, the rotational rate of the rotational spindle is only allowed to vary depending on the position of the contact member in the radial direction of the substrate. The constant relative velocity established in this manner enables a constant surface roughness over the entire surface of the substrate.

The texturing apparatus may further comprise a vibrator connected to the contact member so as to reciprocate the contact member by a predetermined amplitude along the radial direction. The reciprocation of the contact member in the radial direction contributes to establishment of a constant cross angle over the entire surface of the substrate. The cross angle is an angle established between the intersecting fine scratches on the substrate.

Still, the texturing apparatus may further comprise an urging force adjuster connected to the contact member. The urging force adjuster is designed to maintain an urging force of the contact member constant. The contact urging force exerted on the substrate from the contact member greatly contributes to establishment of the aforementioned constant surface roughness and/or cross angle.

The above-described texturing apparatus may be employed to provide a disk-shaped substrate comprising a texture spreading over its surface at least uniformly along the radial direction, for example. In this case, the texture may be defined by the surface roughness, the cross angle, and the like. When a magnetic film is formed on the surface of the textured substrate, the magnetic film reflects the texture. The similar texture is allowed to appear on the surface of the magnetic film. The uniform texture is expected to contribute to realization of a still higher recording density in the obtained magnetic recording disk.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the interior structure of a hard disk drive (HDD);

FIG. 2 is a plan view of a magnetic recording disk along with enlarged views illustrating a texture on the surface of the magnetic recording disk in detail;

FIG. 3 is a sectional view of the magnetic recording disk along with enlarged views illustrating a surface roughness on the surface of the magnetic recording disk in detail;

FIG. 4 is a perspective view schematically illustrating the structure of a texturing apparatus;

FIG. 5 is a partial side view of the texturing apparatus for schematically illustrating a support for a contact roller;

FIG. 6 is a partial front view of the texturing apparatus for schematically illustrating the structure of an urging force adjuster;

FIG. 7 is a block diagram schematically illustrating a control system of the texturing apparatus;

FIG. 8 is a perspective view illustrating a substrate subjected to the contact of an abrasive tape at the innermost position; and

FIG. 9 is a perspective view illustrating the substrate subjected to the contact of the abrasive tape at the outermost position.

### DESCRIPTION OF THE PREFERRED EMBODIMENT

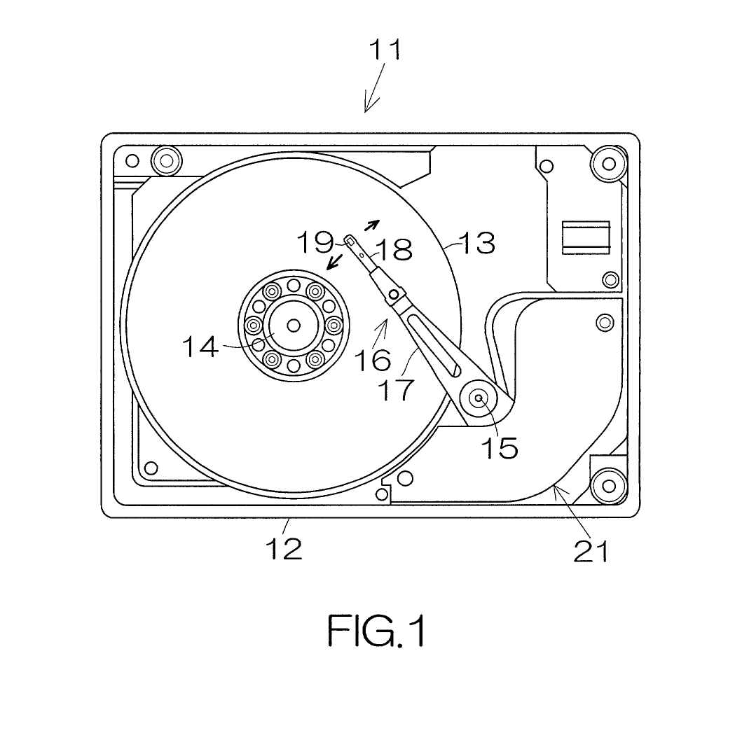

FIG. 1 schematically illustrates the interior structure of a hard disk drive (HDD) 11 as an example of a magnetic recording medium drive or storage device. The HDD 11 includes a box-shaped primary enclosure 12 defining an inner space of a flat parallelepiped, for example. At least one magnetic recording disk 13 is accommodated in the inner space within the primary enclosure 12. The magnetic recording disk 13 is mounted on a driving shaft of a spindle motor 14. The spindle motor 14 is allowed to drive the magnetic recording disk 13 for rotation at a higher revolution rate such as 7,200 rpm or 10,000 rpm, for example. A cover, not shown, is coupled to the primary enclosure 12 so as to define the closed inner space between the primary enclosure 12 and itself.

A carriage 16 is also accommodated in the inner space of the primary enclosure 12 for swinging movement about a vertical support shaft 15. The carriage 16 includes a rigid swinging arm 17 extending in the horizontal direction from the vertical support shaft 15, and an elastic head suspension 18 fixed to the tip end of the swinging arm 17 so as to extend forward from the swinging arm 17. As conventionally known, a flying head slider 19 is cantilevered at the head suspension 18 through a gimbal spring, not shown.

A write head element and a read head element, both not shown, are mounted on the flying head slider 19. The write head element serves to write a magnetic bit data into the magnetic recording disk 13. The read head element is designed to read a magnetic bit data out of the magnetic recording disk 13. The write head element may comprise a thin film magnetic head, for example, utilizing a magnetic field or flux induced in a thin film swirly coil pattern, in forming the magnetic field for recordation at the write gap. The read head element may comprise a magnetoresistive (MR) element, for example, designed to utilize the variation in the electric resistance in response to the reversal of the magnetic polarity in a magnetic field applied from the magnetic recording disk 13. The MR element can be represented by a giant magnetoresistive (GMR) element, a tunnel-junction magnetoresistive (TMR) element, and the like.

The head suspension 18 serves to urge the flying head slider 19 toward the surface of the magnetic recording disk 13. When the magnetic recording disk 13 rotates, the flying head slider 19 is allowed to receive airflow generated along the rotating magnetic recording disk 13. The airflow serves to generate a lift on the flying head slider 19. The flying head slider 19 is thus allowed to keep flying above the surface of the magnetic recording disk 13 during rotation of the magnetic recording disk 13 at a higher stability established by the balance between the lift and the urging force of the head suspension 18. In this case, the flying height of the flying head slider 19 is set in a range between 10 nm and 20 nm, for example. The write and read head elements achieve the write and read operations during the flight of the flying head slider 19.

When the carriage 16 is driven to swing about the support shaft 15 during flight of the flying head slider 19, the flying head slider 19 is allowed to cross the recording tracks defined on the magnetic recording disk 13 in the radial direction of the magnetic recording disk 13. This radial movement serves to position the write and read head elements on the flying head slider 19 right above a target recording track on the magnetic recording disk 13. In this case, an electromagnetic actuator 21 such as a voice coil motor (VCM) can be employed to realize the swinging movement of the carriage 16, for example. As conventionally known, in the case where two or more magnetic recording disks 13 are incorporated within the inner space of the primary enclosure 12, a pair of the elastic head suspensions 18 are mounted on a single common swinging arm 17 between the adjacent magnetic recording disks 13.

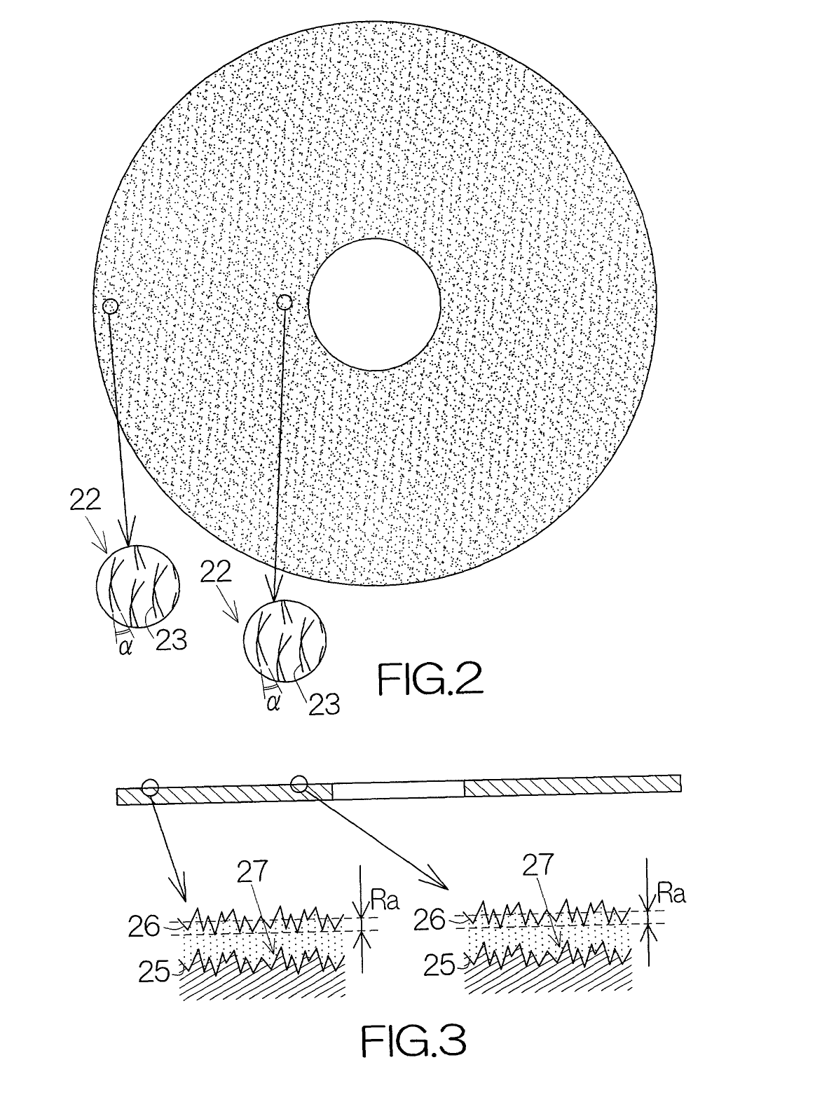

As shown in FIG. 2, a texture 22 is formed on the front and back surfaces of the magnetic recording disk 13. The texture 22 comprises stripes of fine scratches 23. A so-called cross angle α is defined between intersecting fine scratches 23. The texture 22 serves to establish a surface roughness Ra of a predetermined value on the surface of the magnetic recording disk 13.

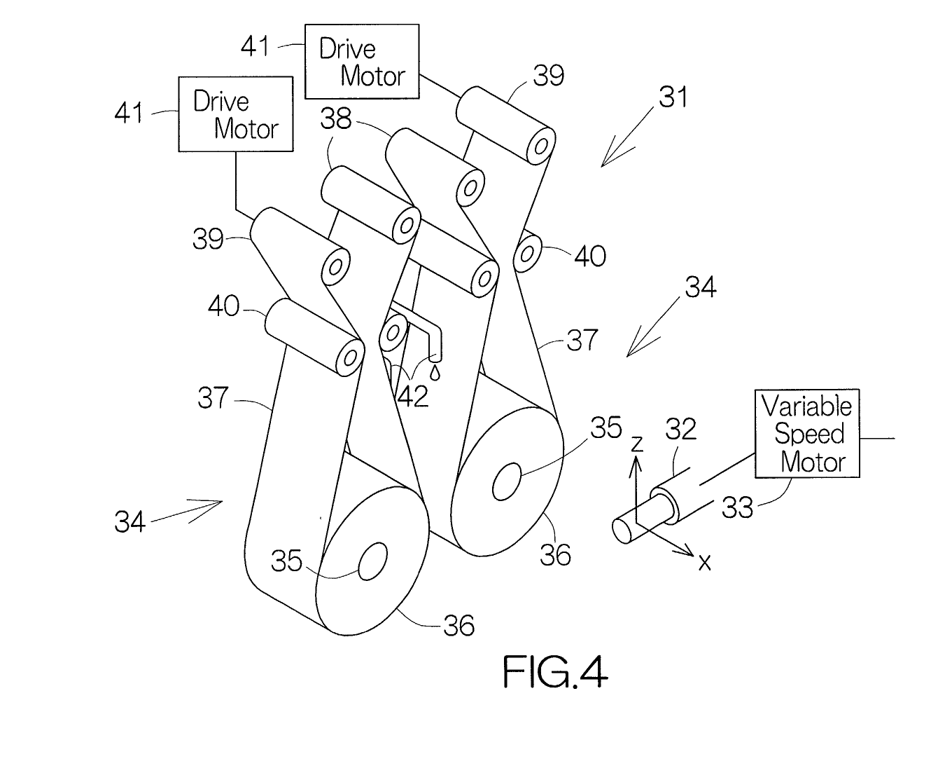

The texture 22 is designed to exhibit the uniformity all over the surfaces of the magnetic recording disk 13, in particular, in the radial direction extending from the center to the periphery. Specifically, the uniform cross angle a of 1.2 degrees, for example, is established all over the surfaces of the magnetic recording disk 13. As is apparent from FIG. 2, the cross angle α of the scratches 23 closer to the center is set equal to the cross angle a of the scratches 23 closer to the periphery. Moreover, the uniform surface roughness Ra of 0.7 nm, for example, is established all over the surfaces of the magnetic recording disk 13, as is apparent from FIG. 3. Namely, the surface roughness Ra in a region closer to the center is set equal to the surface roughness Ra in region closer to the periphery.

As shown in FIG. 3, the magnetic recording disk 13 includes a substrate 25 made from a metallic material such as aluminum or a glass. The substrate 25 may be shaped in a disk. When a glass is employed to form the substrate 25, a metallic lamination may be applied to the surfaces of the glass substrate 25.

As conventionally known, magnetic films 26 are formed to extend on the front and back surfaces of the substrate 25. The magnetic film 26 is designed to hold a magnetic bit data. The magnetic film 26 is designed to have a uniform thickness all over the surface of the substrate 25. The aforementioned texture 22 is thus only a reflection of a texture 27 established on the surface of the substrate 25. A lubricating oil film, not shown, is formed to spread over the surface of the magnetic film 26. The lubricating oil film serves to reduce the friction between the flying head slider 19 and the magnetic recording disk 13.

Even when the flying head slider 19 contacts the surface of the magnetic recording disk 13, the texture 22 is allowed to reliably reduce the adsorption established between the flying head slider 19 and the lubricating oil film spreading over the surface of the magnetic recording disk 13. The flying head slider 19 seated on the surface of the stationary magnetic recording disk 13, for example, cannot disturb the commencement of the rotation of the magnetic recording disk 13. The magnetic recording disk 13 is thus allowed to reliably start rotating irrespective of the contacting flying head slider 19. To the contrary, if a sufficient surface roughness Ra cannot be established on the surface of the magnetic recording disk 13, the magnetic recording disk 13 cannot even start rotating because of the adsorption established between the flying head slider 19 and the magnetic recording disk 13.

Moreover, when the magnetic film 26 is allowed to grow over the texture 27 established on the substrate 25 in the aforementioned manner, a sufficient magnetic anisotropy can be established in the magnetic film 26. The magnetic anisotropy serves to improve the sensitivity of the magnetic recording disk 13. A magnetic bit data can be recorded onto the magnetic recording disk 13 even with a smaller or weaker magnetic field for recordation.

In particular, the uniform surface roughness Ra can be established all over the surf aces of the magnetic recording disk 13 in the aforementioned manner. Accordingly, the constant flying height of the flying head slider 19 can be set irrespective of the movement of the flying head slider 19 in the radial direction of the magnetic recording disk 13 in the HDD 11. Specifically, the surface roughness Ra is simply allowed to have the minimum value enough to prevent adsorption of the flying head slier 19 over the entire surfaces of the magnetic recording disk 13. As compared with a conventional HDD, the flying height of the flying head slider 19 can be reduced at a region closer to the center of the magnetic recording disk 13. A still higher recording density can be achieved in the magnetic recording disk 13.

In addition, the uniform cross angle α can be established all over the surfaces of the magnetic recording disk 13 in the aforementioned manner. Accordingly, the magnetic recording disk 13 is allowed to exhibit the uniform magnetic characteristic all over its surfaces. The uniformity of the magnetic characteristic in this manner is expected to greatly contribute to realization of a still higher recording density.

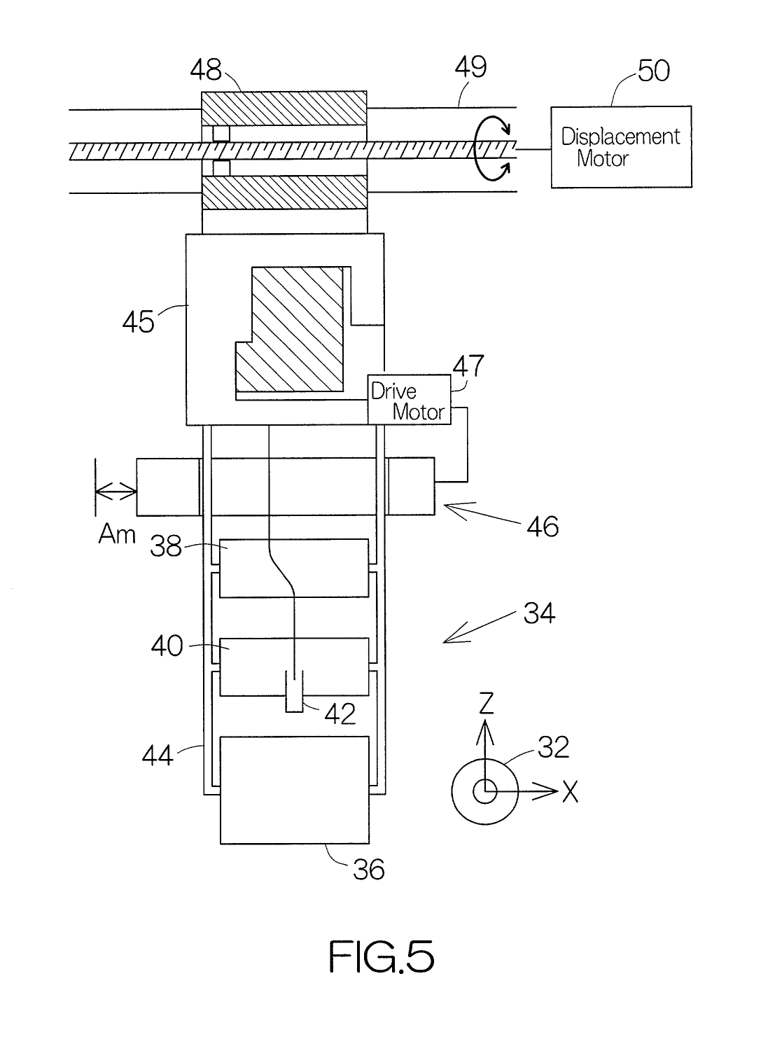

FIG. 4 schematically illustrates a texturing apparatus 31 for establishing the aforementioned uniform texture 27. The texturing apparatus 31 includes a rotational spindle 32 supported for rotation in the attitude perpendicular to a predetermined datum plane, for example. The datum plane may be represented by the vertical plane, namely, the xz coordinate plane of the three-dimensional coordinate system. A drive 33 is connected to the rotational spindle 32 for driving the rotational spindle 32. The drive 33 may comprise an electric motor of a variable motor speed, for example.

A pair of texturing or scratching units 34 are incorporated in the texturing apparatus 31. The texturing units 34 are disposed on opposite sides of the xz coordinate plane so as to get opposed to each other. The individual texturing unit 34 includes a contact member or roller 36 rotatable around a support shaft 35 extending in the horizontal direction in parallel with the xz coordinate plane. In this case, the support shaft 35 is allowed to define the radial direction of the rotational spindle 32. The contact roller 36 may be made of a hard rubber, for example. The contact roller 36 is preferably allowed to have the length significantly smaller than the radius of the magnetic recording disk 13. The length of the contact roller 36 is measured along the support shaft 35.

An abrasive tape 37 is wound around the contact roller 36. The abrasive tape 37 is released from a first roller 38 to the contact roller 36. A second roller 39 is designed to take up the abrasive tape 37 released from the contact roller 36. The first and second rollers 38, 39 are allowed to rotate around rotational axes in parallel with the support shaft 35 of the contact roller 36. Auxiliary or idler rollers 40 are disposed between the first roller 38 and the contact roller 36 as well as between the second roller 39 and the contact roller 36 so as to guide the movement of the abrasive tape 37 along a predetermined path. A drive motor 41 is connected to the second roller 39 so as to drive the second roller 39. The drive motor 41 generates the driving power forcing the second roller 39 to reel the abrasive tape 37. The abrasive tape 37 may be a weave or a nonwoven made from acrylic, cellulose, polyester, rayon, or the like. Alternatively, the abrasive tape 37 may comprise a sponge material including a carrier of polyethylene terephthalate (PET) receiving an urethane lamination over the surface.

A supply tube 42 is disposed between the first roller 38 and the contact roller 36 in the vicinity of the auxiliary roller 40. Abrasive liquid is allowed to drop from the supply tube 42 to the abrasive tape 37 running from the first roller 38 to the contact roller 36. Abrasive grains such as fine diamond particles may be dispersed within the abrasive liquid, for example. The abrasive tape 37 holding the abrasive grains in this manner is thus supplied to the contact roller 36. The supply tube 42 may be connected to a reservoir tank, not shown, which serves to keep supplying the abrasive liquid to the supply tube 42.

As shown in FIG. 5, the individual texturing unit 34 includes a support frame 44 for commonly carrying the rollers 36, 38-40 and the supply tube 42. The support frame 44 is suspended from a first displacement member 45. A vibrator 46 is connected to the support frame 44 so as to reciprocate the support frame 44 on the first displacement member 45 along the direction parallel to the support shaft 35. The vibrator 46 is designed to reciprocate the contact roller 36 by a predetermined amplitude Am along the support shaft 35, namely, in the radial direction of the rotational spindle 32. The vibrator 46 utilizes the driving force from a drive motor 47, for example, so as to induce the reciprocation of the support frame 44.

A second displacement member 48 carries the first displacement member 45. A support beam 49 extends in parallel with the support shaft 35 so as to guide the movement of the second displacement member 48. The support beam 49 serves to realize the movement of the contact roller 36 along the radial direction of the rotational spindle 32. The amount or angle of the rotation in a displacement motor 50 is allowed to set the displacement or movement amount of the second displacement member 48, for example.

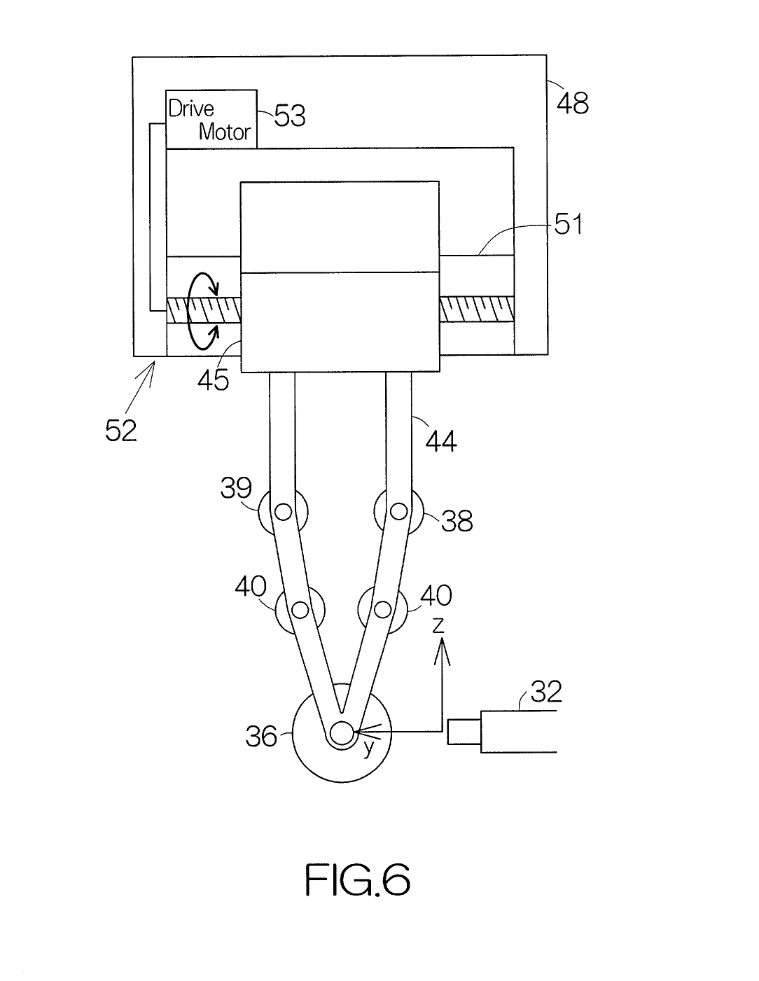

As shown in FIG. 6, a guide beam 51 is incorporated within the second displacement member 48 so as to extend in parallel with the rotational spindle 32. The guide beam 51 is designed to receive the first displacement member 45. An urging force adjuster 52 is connected to the first displacement member 45. The urging force adjuster 52 is designed to drive the first displacement member 45 on the second displacement member 48 in parallel with the rotational spindle 32. The urging force adjuster 52 is allowed to urge the first displacement member 45 toward the xz coordinate plane and to pull back the first displacement member 45 from the xz coordinate plane with the assistance of the driving force from a drive motor 53, for example.

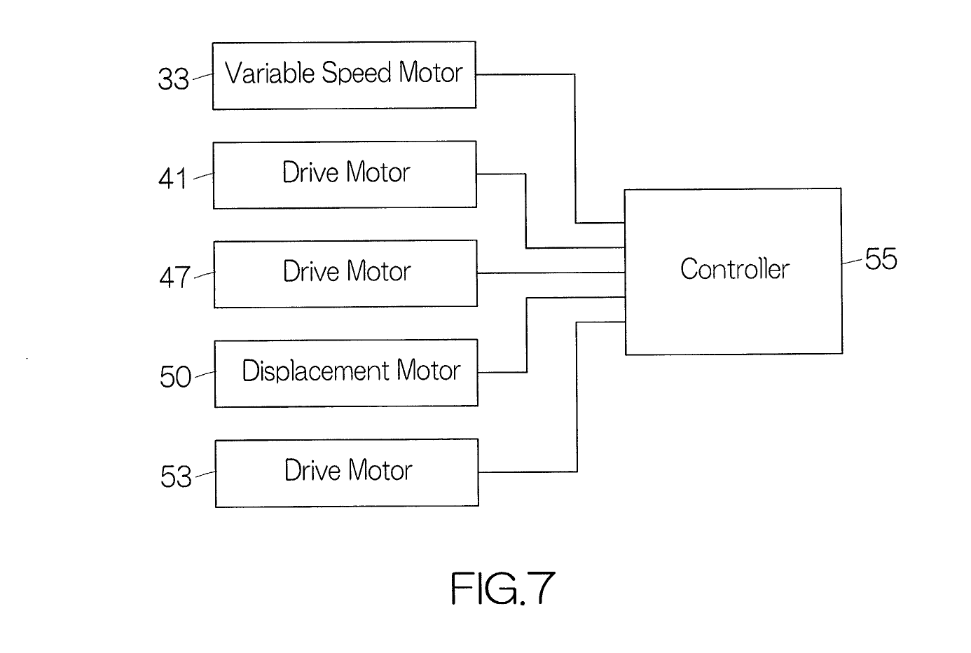

A controller 55 is incorporated within the texturing apparatus 31. As shown in FIG. 7, for example, the controller 55 is connected to the drive 33, the drive motor 41, the drive motor 47, the displacement motor 50 and the drive motor 53, respectively. The controller 55 is designed to control or manage the operation of the drive 33, the drive motor 41, the drive motor 47, the displacement motor 50 and the drive motor 53 in accordance with a predetermined processing or software program. The software program may be loaded into the controller 55 through an interface connected to any exterior device, for example. Alternatively, the software program may previously be stored in a memory chip, not shown, incorporated within the controller 55.

Next, a brief description will be made on the operation of the texturing apparatus 31. First of all, the disk-shaped substrate 25 for a recording medium after a flattening polishing treatment is mounted on the rotational spindle 32. The flattening polishing treatment is expected to establish the surface roughness Ra of approximately 0.2 nm over the surfaces of the substrate 25, for example. The drive 33 rotates the rotational spindle 32 at an initial rotation rate in accordance with the instructions signal output from the controller 55. The substrate 25 starts rotating around the axis of the rotational spindle 32 within the xz coordinate plane.

The contact rollers 36 of the texturing units 34 are then positioned relative to the substrate 25. In this case, the displacement motor 50 drives the second displacement member 48 along the support beam 49 in accordance with the instructions signal output from the controller 55. The abrasive tapes 37 over the surfaces of the contact rollers 36 are respectively opposed to the front and back surfaces of the rotating substrate 25 at the innermost position in the radial direction of the substrate 25.

The abrasive tapes 37 then start receiving the abrasive liquid from the supply tubes 42 in the texturing units 34. Simultaneously, the second rollers 39 start reeling the abrasive tapes 37, respectively. The abrasive tapes 37 receiving the abrasive liquid are continuously supplied to the individual contact rollers 36 in this manner.

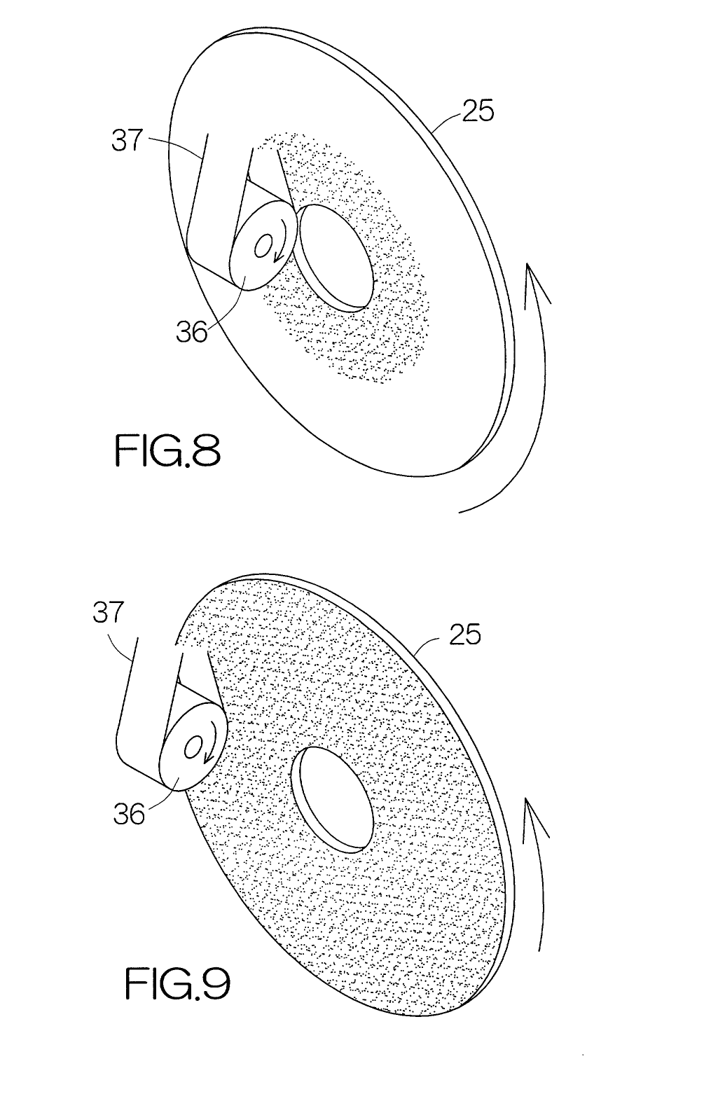

As shown in FIG. 8, for example, the contact rollers 36 are thereafter urged against the rotating substrate 25. The drive motor 53 is in this case designed to move the first displacement member 45 along the guide beam 51 in accordance with the instructions signal supplied from the controller 55. A linear contact can be established between the contact roller 36 and the surface of the substrate 25 at the radius. When the abrasive tape 37 on the contact roller 36 is urged against the surface of the rotating substrate 25 in this manner, the abrasive grains adhered to the abrasive tape 37 generate the fine scratches 23 on the surface of the substrate 25. The urging force adjuster 52 operates to maintain a constant urging force of the contact roller 36 with the assistance of the drive motor 53. The generated fine scratches 23 serve to establish the surface roughness Ra of 0.7 nm, for example.

The vibrator 46 realizes the reciprocation of the contact roller 36 in contact with the surface of the rotating substrate 25 by the predetermined amplitude Am in the radial direction of the substrate 25. When the rotation of the rotational spindle 32 is combined with the reciprocation of the contact roller 36 in this manner, the fine scratches 23 are allowed to establish the cross angle α of 1.2 degrees on the surface of the substrate 25 in the aforementioned manner.

The contact roller 36 is allowed to move in the radial direction of the rotating substrate 25 or the centrifugal direction of the rotational spindle 32. The controller 55 is designed to supply the instructions signal to the displacement motor 50. The displacement motor 50 causes the movement of the second displacement member 48 along the support beam 49. The contact roller 36 may stepwise move in the centrifugal direction. Alternatively, the contact roller 36 may constantly move in the centrifugal direction.

In this case, the rotation rate of the rotational spindle 32 is varied in accordance with the movement amount of the contact roller 36 in the centrifugal direction. The controller 55 is designed to control the rotation rate so as to maintain the relative velocity u between the contact roller 36 and the rotating substrate 25. Specifically, the remoter the contact roller 36 gets from the rotational spindle 32, the slower rate is set for the rotation of the rotational spindle 32. If the relative velocity u is set constant in this manner, the abrasive liquid is allowed to have a constant thickness h between the contact roller 36 and the surface of the substrate 25, as shown below.

$$\frac{h}{R} = 4.89 \frac{η u}{w / L} \qquad [ Equation ]$$

Here, the constant R denotes the radius of the contact roller 36. The constant denotes the viscosity of the abrasive liquid. The constant w corresponds to the urging force of the contact roller 36. The constant L corresponds to the length of the linear contact established between the contact roller 36 and the substrate 25.

As shown in FIG. 9, when the relative velocity u is kept constant during the movement of the contact roller 36 from the innermost position to the outermost position of the substrate 25, the constant and uniform surface roughness Ra of 0.7 nm, for example, can be established all over the surface of the substrate 25. Simultaneously, the constant cross angle a of 1.2 degrees can be established between the respective intersecting fine scratches 23 all over the surface of the substrate 25. On the other hand, if the rotation rate is kept constant for the rotational spindle 32, the relative velocity u gets smaller at a region closer to the rotational spindle 32. Even if the condition such as the surface roughness Ra of 0.7 nm and the cross angle α of 1.2 degrees is established at the outermost position of the substrate 25, the surface roughness Ra and the cross angle reach approximately 0.8 nm and 2.6 degrees, respectively, at the innermost position, for example.

As is apparent from the aforementioned Equation, if the ratio between the relative velocity u and the urging force W is maintained constant in the texturing apparatus 31, it is possible to establish a constant surface roughness Ra and a constant cross angle α all over the surface of the substrate 25. Specifically, in case where the rotation rate of the rotational spindle 32 is maintained constant, the urging force W is only allowed to follow the variation in the relative velocity u so as to keep the ratio u/W constant. The urging force w in this manner can be controlled on the basis of the operation of the controller 55.

What is claimed is:

1. A texturing apparatus for a recording medium substrate, comprising:
a rotational spindle supported for rotation in an attitude perpendicular to a predetermined datum plane;
a contact member supported for movement in a radial direction of the rotational spindle along the datum plane; and
a drive connected to the rotational spindle so as to vary a rotation rate of the rotational spindle in response to movement of the contact member.

2. The texturing apparatus according to claim 1, further comprising a vibrator connected to the contact member so as to reciprocate the contact member by a predetermined amplitude along the radial direction.

3. The texturing apparatus according to claim 2, further comprising an urging force adjuster connected to the contact member so as to maintain an urging force of the contact member constant, said urging force exerted on a substrate for a recording medium mounted on the rotational spindle.

4. A method of texturing a substrate for a recording medium, comprising:
contacting a contact member against the substrate of a disk-shape rotating around a rotational spindle;
moving the contact member in a radial direction of the substrate; and
varying a rotation rate of the substrate around the rotational spindle in accordance with movement of the contact member.

5. The method of texturing according to claim 4, further comprising reciprocating the contact member in contact with the substrate by a predetermined amplitude along the radial direction.

6. The method of texturing according to claim 5, wherein a constant urging force is applied from the contact member to the substrate irrespective of the movement of the contact member.

7. A disk-shaped substrate for a recording medium, comprising a texture spreading over a surface at least uniformly along a radial direction.

8. The disk-shaped substrate according to claim 7, wherein said texture is defined by a surface roughness.

9. The disk-shaped substrate according to claim 7, wherein said texture is defined by a cross angle.

10. The disk-shaped substrate according to claim 7, wherein said texture is defined by a combination of a surface roughness and a cross angle.

11. A disk-shaped recording medium comprising:
a disk-shaped substrate;
a magnetic film superposed over a surface of the substrate; and
a texture spreading over a surface of the magnetic film at least uniformly along a radial direction of the substrate.

12. The disk-shaped recording medium according to claim 11, wherein said texture is defined by a surface roughness.

13. The disk-shaped recording medium according to claim 11, wherein said texture is defined by a cross angle.

14. The disk-shaped recording medium according to claim 11, wherein said texture is defined by a combination of a surface roughness and a cross angle.
